(19) United States
(12) Patent Application Publication
(10) Pub. No.: US 2003/0222623 A1
(43) Pub. Date: Dec. 4, 2003

(54) Method of charging a battery

(76) Inventor: Hardei Wae, Taipei City (TW)

Correspondence Address: Grand Level Technology Corp., P. O. Box No. 6-57, Junghe, Taipei, 235, TW

(21) Appl. No.: 10/439,235

(22) Filed: May 16, 2003

(30) Foreign Application Priority Data
May 29, 2002 (TW) 091111632

(51) Int. Cl. H02J 7/04

(52) U.S. Cl. 320/141

(57) ABSTRACT

A method of charging a battery capable of eliminating the occurrence of battery memory effect thereby fully utilizing the chargeable space inside the battery to achieve a saturated status mainly starts to discharge the battery in an impulse wave, then uses an extremely small impulse current to start the charge. The impulse current increases gradually and finally reaches a steady change range. Zero or more than zero small impulse wave exists between every two charging impulse waves.

### BACKGROUND OF THE INVENTION

1) Field of the Invention

The present invention relates to a method of charging, more particularly to a method of charging a battery through fully utilizing the chargeable space therein to achieve a very saturated status.

2) Description of the Prior Art

Currently, a chargeable battery or an accumulator has convenienced the application since the chargeable property thereof eliminates mass purchase of non-recyclable and non-chargeable batteries so as to reduce unnecessary environmental pollution to the Earth.

A memory effect features the accumulator; that means, after the battery continuously and rapidly discharges the voltage to a lower electric potential, the voltage of the battery will rise again if the discharge stops. However, most of the time, the risen voltage is virtual; to discharge the battery again will rapidly drop the voltage to a low electric potential. The actual or virtual extent of the virtual voltage is mainly of a direct ratio with the electric amount discharged within a unit time of the battery. The more the electric amount discharges within a unit time, the more virtual the voltage will be.

During the charging procedure, if the battery is charged before the virtual voltage is discharged completely, only the measurement of the voltage or the voltages of the battery achieves the regulated fullness; therefore the inner virtual voltage area has an energy fault even the battery is fully charged; that means, the inner portion of the battery is not specifically, effectively and fully charged. Furthermore, nonlinear discharge might occur when using the abovementioned battery; that means, although 4 bars indicate that the capacity of the battery is fully charged and the front two bars last for two or three days, the final two bars might only last for half a day.

Frequent occurrence of the energy fault might cause high internal resistance to disable the full charge at that certain area inside the battery thereby forming another memory effect which is a major shortcoming.

Actually, a smaller initial current is capable of specifically accomplishing the chemical reaction. However, most of the chargers use a strong and steady electric current to charge the battery. Although that achieves a rapid charging effect, the battery generates heat during the charging procedure to cause glasshouse effect in an environment with warm ambient temperature. After a long time, the heated temperature causes the liquid in the battery to leak thereby shortening the battery life.

In view of the shortcomings of the conventional chargers, the inventor of the present invention researched and developed a method of charging a battery and a circuit thereof to overcome the abovementioned disadvantages.

### SUMMARY OF THE INVENTION

One of the objectives of the present invention is to provide a method of charging a battery capable of preventing the battery from heating up, fully accomplishing a chemical reaction, eliminating liquid leakage and explosion, as well as extending the battery life.

Another objective of the present invention is to provide a method of charging a battery capable of preventing internal degeneration and maintaining the charging amount close to that of a new battery even after a long application time.

Yet another objective of the present invention is to provide a method of charging a battery capable of charging a lot of more energy than a regular charger such that the battery has a longer application time.

Yet another objective of the present invention is to provide a method of charging a battery capable of making more effective linear discharge than a regular battery; that means, the application time of each of the battery capacity indicated in the bars has a similar length.

Still another objective of the present invention is to provide a method of charging a battery capable of reducing memory effect thereby indirectly protecting a mobile phone circuit and extending the battery life thereof.

To achieve the abovementioned objectives, the present invention comprises the following steps:

(a) discharging the battery in an impulse wave within a preset time period (ten to forty minutes or longer);

(b) dividing the entire charging procedure into one to five stages; wherein the first four stages use a gradually increasing electric current in a small impulse wave to charge the battery; the fifth stage uses a stronger impulse current without making tremendous changes;

(c) starting charge from the first stage, detecting the voltage of the battery and calculating the charging time;

(d) conducting this step after the first stage is finished according to the measured rise value (dv/dt) of the voltage within a unit time; if the rise value (dv/dt) exceeds the prediction, the battery stays at the original stage or returns to the previous stage for more charge;

(e) moving to the next charging stage if the rise value (dv/dt) matches with the prediction;

(f) repeating steps (d) and (e) after finishing step (e) until reaching the fifth stage;

(g) ending the battery charging until the voltage is saturated.

To enable a further understanding of the features and implementation of the present invention, the brief description of the drawings is followed by the detailed description of a preferred embodiment.

### BRIEF DESCRIPTION OF THE DRAWINGS

FIG. 1 is a flow chart of the first exemplary embodiment of the present invention.

FIG. 2 is a time series drawing of a discharge load of an impulse wave of the present invention.

FIG. 3 is a relationship drawing of the charging voltage of the present invention against the time.

FIG. 4 is a relationship drawing of the charging electric current of the present invention against the time.

FIG. 5 is an enlarged drawing of a partial impulse current showed in 4a of FIG. 4.

FIG. 6 is an enlarged drawing of a partial impulse current showed in 4b of FIG. 4.

FIG. 7 is a flow chart of the second exemplary embodiment of the present invention.

### DETAILED DESCRIPTION OF THE PREFERRED EMBODIMENTS

Mainly, the present invention first discharges the battery with an impulse wave and then uses an extremely small impulse wave to charge the battery; the extreme small impulse current increases slowly to finally reaches a steady status; zero or more than zero of small impulse current exists between two charging impulse currents. The principles and advantages of the present invention are as follows:

(1) As mentioned previously, when being continuously and rapidly discharged, the battery forms a memory effect; as the same, continuous and rapid charging also forms a memory effect. The main reason thereof is that continuity and rapidness fail to fully finish the chemical reaction inside a battery since the positive and negative ion are unable to separate specifically. Therefore, discharging with an impulse wave first and then charging with an impulse wave changes the status of continuously and rapidly discharging and charging thereby overcoming the memory effect to finish the chemical reaction inside the battery completely, separating the positive and the negative ion specifically and charging the battery more fully.

(2) When discharging the battery in impulse waves to a low potential, for V≈IR, if the internal resistance (R) in the battery is fixed and the voltage (V) of the battery is discharged to the low potential, then the charging current (I) gradually decreases too thereby protecting the internal structure of the battery from damage; when the voltage (V) of the battery gradually charged, the charging current (I) gradually increases also. That is the best charging method and the principle that present invention is based on. It starts with an extremely small impulse current which gradually increases to finally stop increasing when the voltage (V) reaches closely to the regulated one; with zero or more than zero small impulse current for further destroying the memory effect of the battery, it charges the battery more fully.

(3) Therefore, first the impulse discharge finishes the chemical reaction completely thereby specifically separating the positive and the negative ion to fully discharge the battery; then the impulse current charges the battery closely to a saturated status.

(4) No internal resistance occurs inside the battery thereby lowering the chemical reaction effect, reducing the charging energy and preventing the occurrence of the memory effect; therefore when the battery is loaded, the relationship between the voltage and the time thereof is close to a linear relationship.

(5) No continuous electric current is used during the charging procedure, therefore, the chemical reaction of the battery is complete; the quality of the battery does not deteriorate and the working life thereof is extended.

The present invention is applicable to devices to be charged, such as a notebook computer, a digital camera, a personal digital assistant, a mobile phone, etc. It can be a built-in device inside a machine or disposed externally on an independent electric appliance.

The following exemplary embodiments use an accumulator of the mobile phone for description, wherein, the battery itself does not have a single battery for particularly controlling a circuit.

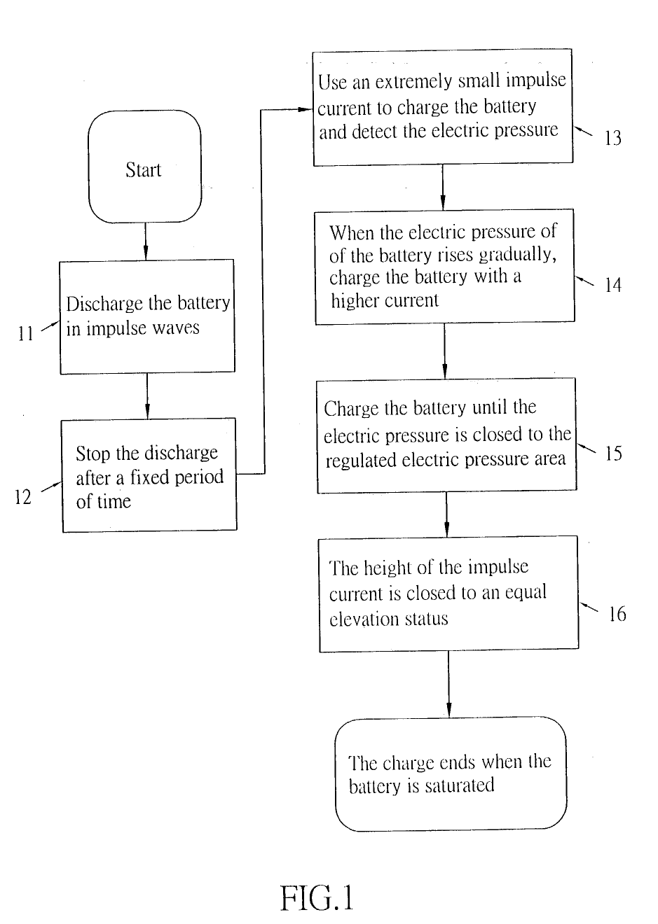

In the first embodiment, FIG. 1 is the flow chart of the first exemplary embodiment and comprises the following steps:

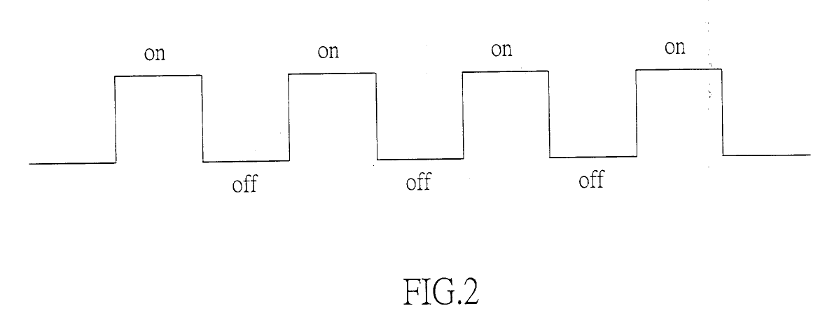

Step (11) discharges the battery in impulse waves by loading the battery; as indicated in FIG. 2, the load is controlled to stay in an opening status or a breaking status for a certain period of time; the frequency of the impulse wave is between 0.01 and 100 Hz; during the opening status, the electric current consumed by the battery is approximately between 10 mA and 40 mA; wherein, for a lithium battery, the electric current consumed by the battery is between 30 mA and 40 mA; for a nickel battery, the electric current consumed by the battery is between 10 mA and 40 mA; the time ratio between the loaded opening status and breaking status is not strictly limited.

Step (12) stops the discharge after a fixed period of time (ten to forty minutes or longer); within said time period, the battery with almost no electric power discharges to a low electric potential of 0.9V; the battery with a lot of electric power discharges the risen virtual voltage completely and discharges only a little part of the voltage without wasting too much energy in the battery that still has some electric power. Within said time period, when the charged battery almost has no power, the discharge stops at a preset low electric potential of 0.9V; when the virtual voltage rises again to exceed the preset discharge electric potential level of 1.5V, it starts to discharge again. The action repeats for several times until the height of the risen virtual voltage does not exceed the preset discharge electric potential level. When the battery to be charged still has a lot of electric power, the discharge action stops as soon as the preset time is up. The above data of the step (12) is for a simple battery; however, a controlling circuit of a lithium battery stops the discharge of the battery when the potential level reaches between 2.4V and 2.9V and of course, that is of another issue.

Step (13) uses an extremely small impulse current to charge the battery and detect the voltage thereof; the frequency of the impulse current for charging is between 0.5 and 100 Hz.

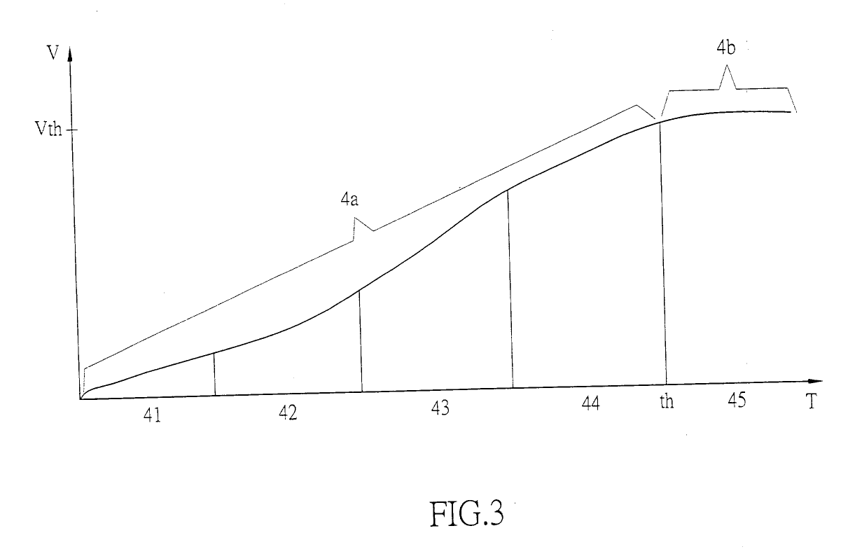

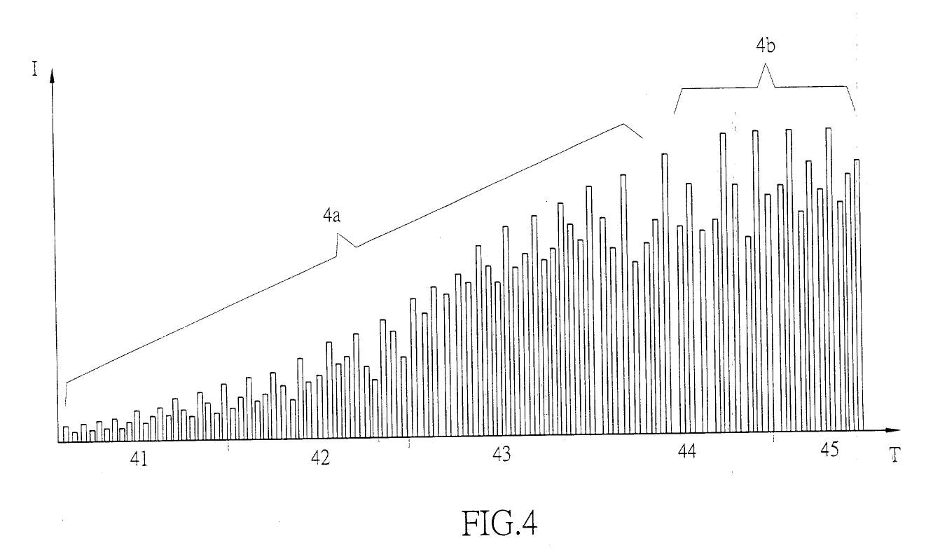

In step (14), when the voltage of the battery rises gradually, as indicated in FIG. 3 of the relationship drawing of the voltage of the battery against the time, the impulse current increases gradually also, as indicated in 4a of FIG. 4 which is the relationship drawing of the electric current of the battery against the time.

Step (15) charges the battery until the voltage thereof is charged to a certain height (Vth) which is close to the regulated voltage area.

In step (16), the greater impulse current does not change tremendously, but changes in a slope to get close to a zero status or an equal elevation status, as indicated in 4b of FIG. 4; the charge ends when the battery is saturated.

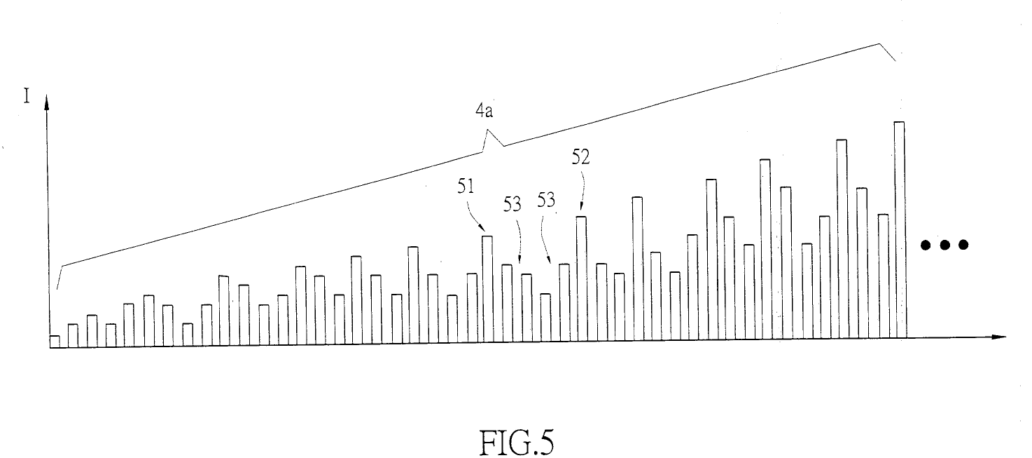

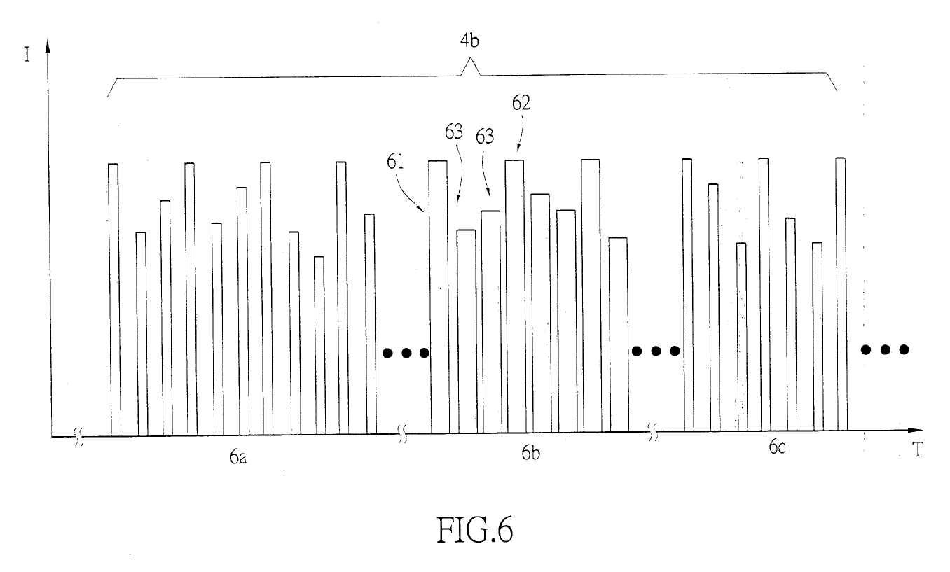

Zero or more than zero small impulse wave exists between any two of the abovementioned steps (13, 14, 15, 16); FIGS. 15 and 16 are respectively the partially enlarged drawings of 4a and 4b of FIG. 4. In FIG. 5, zero or more than zero small impulse wave (53) exists between two charging impulse waves (51, 52); in FIG. 6, zero or more than zero small impulse wave (63) exists between two charging impulse waves (61, 62). However, with the small impulse waves (53, 63) added inbetween, the frequency of the charging impulse current remains between 0.5 and 100 Hz.

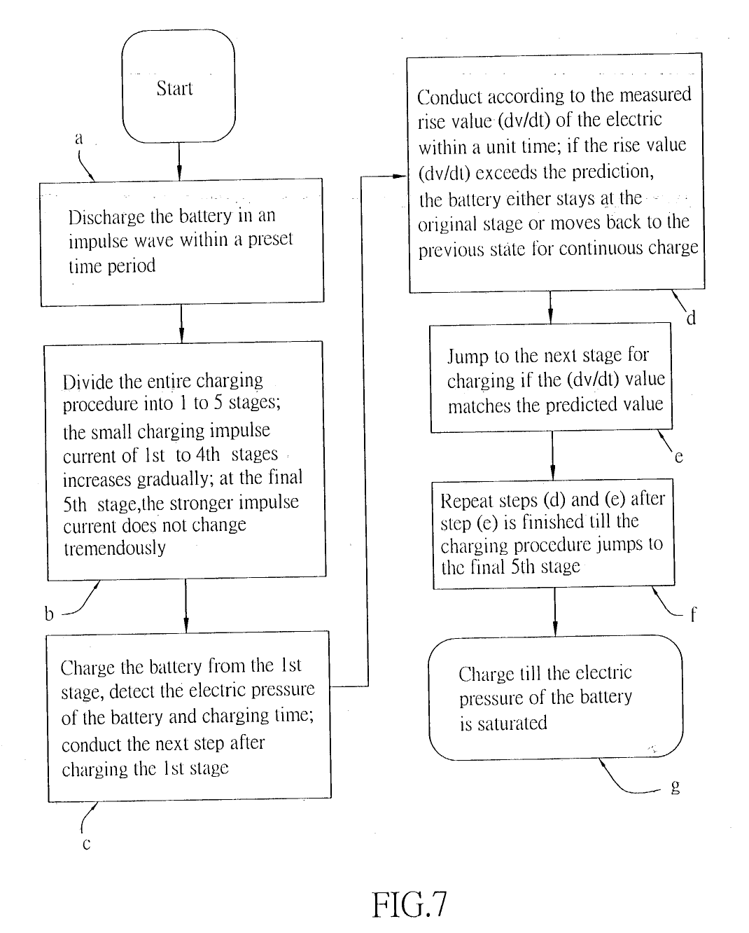

In the second embodiment, FIG. 7 is the flow chart of the second exemplary embodiment and comprises the following steps:

Step (a) discharges the battery in impulse waves by loading the battery within a preset time (ten to forty minutes or longer); as indicated in FIG. 2, the load is controlled to stay in an opening status or a breaking status for a certain period of time; the frequency of the impulse wave is between 0.01 and 100 Hz; during the opening status, the electric current consumed by the battery is approximately between 10 mA and 40 mA; wherein, for a lithium battery, the electric current consumed by the battery is between 30 mA and 40 mA; for a nickel battery, the electric current consumed by the battery is between 10 mA and 40 mA; the time ratio between the loaded opening status and breaking status is not strictly limited. The discharge stops after the preset period of time (ten to forty minutes or longer) is up; within said time period, the battery with almost no electric power discharges to a low electric potential of 0.9V; the battery with a lot of electric power discharges the risen virtual voltage completely and discharges only a little part of the voltage without wasting too much energy in the battery that still has some electric power. Within said time period, when the charged battery almost has no power, the discharge stops at a preset low electric potential of 0.9 V; when the virtual voltage rises again to exceed the preset discharge electric potential level of 1.5V, it starts to discharge again. The action repeats for several times until the height of the risen virtual voltage does not exceed the preset discharge electric potential level. When the battery to be charged still has a lot of electric power, the discharge action stops as soon as the preset time is up. The above data of the step (a) is for a simple battery; however, a controlling circuit of a lithium battery stops the discharging of the battery when the potential level reaches between 2.4V and 2.9V; of course, that is of another issue.

Step (b) divides the entire charging procedure into one to five stages; the voltage has five stages (41, 42, 43, 44, 45) as indicated in FIG. 3; the electric current has five stages (41, 42, 43, 44, 45) as indicated in FIG. 4; wherein the first four stages (41, 42, 43, 44) use a gradually increasing electric current in small impulse waves to charge the battery; at the fifth stage (45), the voltage of the battery is close to the regulated voltage; at this time, the stronger impulse current does not change tremendously. Zero or more than zero small impulse wave, as indicated in FIGS. 5 and 6, exists between any two charging impulse current thereby further preventing a memory effect so as to charge the battery more saturated. However, with the small impulse waves added inbetween, the frequency of the charging impulse current remains between 0.5 and 100 Hz. At the fifth stage (45), the charging impulse wave is divided into three segments with a duty cycle of ⅓, ⅔ and ⅓ respectively thereby achieving a desired charging effect; however, the ratios are not strictly required.

Step (c) starts charge from the first stage, detects the voltage of the battery and calculates the charging time;

Step (d) starts after the first stage is finished and conducts according to the measured rise value (dv/dt) of the voltage within a unit time; if the rise value (dv/dt) exceeds the prediction, that means the battery at this stage has higher internal resistance which disables a saturated charge of the voltage; therefore, the battery stays at the original stage or returns to the previous stage for more charge; repetitively charging the battery with a low impulse current slowly eliminates the internal resistance of the battery and saturates the charge more. Another possible reason is that the battery to be charged has a smaller regulated voltage, therefore repetitively charging with a low impulse current is capable of preventing the damage to the battery.

In step (e), if the rise value (dv/dt) matches with the prediction, that means the battery at this stage is in a normal status, then the next charging stage with higher charging impulse current conducts.

Step (f) repeats steps (d) and (e) after the step (e) is finished till the fifth stage (45) is reached.

Step (g) ends the battery charging when the voltage is saturated.

In said embodiment, the method used at step (g) for charging the voltage of the battery to saturation is to return the procedure to the fifth stage (45) for another charge after the fifth stage (45) is finished; therefore, it seems that the energy of the battery is squeezed in a certain way to achieve a full charge.

The third exemplary embodiment of the present invention is an implementation with a slight alternation of the second embodiment and comprises the following steps:

Step (a) is the same as the step (a) of the second embodiment.

Step (b) is the same as the step (b) of the second embodiment.

Step (c) detects the voltage of the battery, jumps to a certain stage for the detected voltage for charging and measures the time (dt); it moves to the next step after the certain stage is finished.

Step (d) is the same as the step (d) of the second embodiment.

Step (e) is the same as the step (e) of the second embodiment.

Step (f) is the same as the step (f) of the second embodiment.

Step (g) is the same as the step (g) of the second embodiment.

In said embodiment, the method used at step (g) for charging the voltage of the battery to saturation is to return the procedure to the fifth stage (45) for another charge after the fifth stage (45) is finished; therefore, it seems that the energy of the battery is squeezed in a certain way to achieve a full charge.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A method of charging a battery comprises the steps of:
(a) discharging the battery in an impulse wave within a preset time period by loading the battery; a load is controlled to stay in an opening status or a breaking status for a certain period of time;
(b) charging the battery with an extremely small impulse current and detecting the voltage of the battery; when the voltage thereof gradually rises, the extremely small impulse current increases gradually also; the stronger impulse current stops making tremendous changes when the voltage of the battery is charged to a very high level and ends when the battery is charged to a saturation.

2. The method of charging a battery according to claim 1, wherein the frequency of a discharging impulse wave in the step (a) is between 0.01 to 100 Hz.

3. The method of charging a battery according to claim 1, wherein the load in step (a) is controlled to stay in an opening status for a certain period of time; the consumed electric current of the battery is between 10 mA and 40 mA.

4. The method of charging a battery according to claim 1, wherein the preset time in step (a) is between ten to forty minutes or longer.

5. The method of charging a battery according to claim 4, wherein within the preset time and when the battery to be charged is almost out of power, the charge stops when the battery discharges to a low electric potential; the discharge starts again when a virtual voltage rises again to exceed the preset discharge potential level; said action repeats for several times till the risen height of the virtual voltage does not exceed the preset potential level for discharge.

6. The method of charging a battery according to claim 4, wherein within the preset time, if the battery to be charged still has a lot of power, the discharge finishes as soon as the preset time is up.

7. The method of charging a battery according to claim 1, wherein the certain period of preset time in step (a) fitly discharges the battery with almost no power to a low potential and discharges all of the risen virtual voltage of the battery with a lot of power as well as discharges only a little voltage.

8. The method of charging a battery according to claim 1, wherein in the step (b), zero or more than zero small impulse wave exists between any two charging impulse waves; with the added impulse currents, the frequencies of all of the charging currents in the step (b) are between 0.5 to 100 Hz.

9. A method of charging a battery comprises the steps of:
(a) discharging the battery in an impulse wave within a preset time period by loading the battery; a load is controlled to stay in an opening status or a breaking status for a certain period of time;
(b) dividing the entire charging procedure into 1 to N stages; the small charging impulse current of 1 to N1 stages increases gradually; at the final N stages, the stronger impulse current does not change tremendously; wherein, 1<N and N is a natural number;
(c) starts charge from the first stage, detects the voltage of the battery and calculates the charging time;
(d) starts after the first stage is finished and conducts according to the measured rise value (dv/dt) of the voltage within a unit time; if the rise value (dv/dt) exceeds the prediction, the battery either stays at the original stage or moves back to the previous stage for continuous charge;
(e) jumps to the next stage for charging if the (dv/dt) value meets the predicted value;
(f) repeats steps (d) and (e) after the step (e) is finished till the charging procedure jumps to the final N stage;
(g) charges till the voltage of the battery is saturated.

10. The method of charging a battery according to claim 9, wherein the frequency of the discharging impulse wave in the step (a) is about 0.01 to 100 Hz and that in the step (b) is about 0.5 to 100 HZ.

11. The method of charging a battery according to claim 9, wherein the load in the step (a) is controlled to be in an opening status for a period of time; the consumed electric current of the battery is between 10 mA and 40 mA.

12. The method of charging a battery according to claim 9, wherein the preset time in the step (a) is ten to forty minutes or longer.

13. The method of charging a battery according to claim 12, wherein when the battery to be charged is almost out of power, the charge stops when the battery discharges to a low electric potential; the discharge starts again when a virtual voltage rises again to exceed the preset discharge potential level; said action repeats for several times till the risen height of the virtual voltage does not exceed the preset potential level for discharge.

14. The method of charging a battery according to claim 12, wherein within the preset time, if the battery to be charged still has a lot of power, the discharge finishes as soon as the preset time is up.

15. The method of charging a battery according to claim 9, wherein the certain period of preset time in step (a) fitly discharges the battery with almost no power to a low potential and discharges all of the risen virtual voltage of the battery with a lot of power as well as discharges only a little voltage.

16. The method of charging a battery according to claim 9, wherein in the step (b), zero or more than zero small impulse wave exists between any two charging impulse waves; with the added impulse currents, the frequencies of all of the charging currents in the step (b) are between 0.5 to 100 Hz.

17. The method of charging a battery according to claim 9, wherein the step (g) saturates the electric current of the battery by returning to the N stage to charge again after the N stage is finished.

18. A method of charging a battery comprises the steps of:
(a) discharging the battery in an impulse wave within a preset time period by loading the battery; a load is controlled to stay in an opening status or a breaking status for a certain period of time;
(b) dividing the entire charging procedure into 1 to N stages; the small charging impulse current of 1 to N1 stages increases gradually; at the final N stages, the stronger impulse current does not change tremendously; wherein, 1<N and N is a natural number;
(c) detects the voltage of the battery, jumps to a certain stage for charging according to the detected result, measures the time (dt) and conducts the step (d) after a certain stage is finished;
(d) conducts according to the measured rise value (dv/dt) of the voltage within a unit time; if the rise value (dv/dt) exceeds the prediction, the battery either stays at the original stage or moves back to the previous state for continuous charge;
(e) jumps to the next stage for charging if the (dv/dt) value matches the predicted value;
(f) repeats steps (d) and (e) after the step (e) is finished till the charging procedure jumps to the final N stage;
(g) charges till the voltage of the battery is saturated.

19. The method of charging a battery according to claim 18, wherein the frequency of the discharging impulse wave in the step (a) is about 0.01 to 100 Hz and that in the step (b) is about 0.5 to 100 Hz.

20. The method of charging a battery according to claim 18, wherein a load in step (a) is controlled to stay in an opening status for a certain period of time; the consumed electric current of the battery is between 10 mA and 40 mA.

21. The method of charging a battery according to claim 18, wherein the preset time in step (a) is between ten to forty minutes or longer.

22. The method of charging a battery according to claim 21, wherein when the battery to be charged is almost out of power, the charge stops when the battery discharges to a low electric potential; the discharge starts again when a virtual voltage rises again to exceed the preset discharge potential level; said action repeats for several times till the risen height of the virtual voltage does not exceed the preset potential level for discharge.

23. The method of charging a battery according to claim 21, wherein within the preset time, if the battery to be charged still has a lot of power, the discharge finishes as soon as the preset time is up.

24. The method of charging a battery according to claim 18, wherein the certain period of preset time in step (a) fitly discharges the battery with almost no power to a low potential and discharges all of the risen virtual voltage of the battery with a lot of power as well as discharges only a little voltage.

25. The method of charging a battery according to claim 18, wherein in the step (b), zero or more than zero small impulse wave exists between any two charging impulse waves; with the added impulse currents, the frequencies of all of the charging currents in the step (b) are between 0.5 to 100 Hz.

26. The method of charging a battery according to claim 18, wherein the step (g) saturates the electric current of the battery by returning to the N stage to charge again after the N stage is finished.
